(19) United States
(12) Patent Application Publication
(10) Pub. No.: US 2008/0012524 A1
(43) Pub. Date: Jan. 17, 2008

(54) CHARGEABLE ELECTRONIC DEVICES AND DIRECT CURRENT VOLTAGE SUPPLY SYSTEMS

(75) Inventor: Yueh Yu, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/769,644

(22) Filed: Jun. 27, 2007

(30) Foreign Application Priority Data
Jun. 30, 2006 (TW) TW95123764

(51) Int. Cl. H02J 7/00; H02J 7/02

(52) U.S. Cl. 320/103; 320/137

(57) ABSTRACT

A chargeable electronic device charged by an external power supply and comprising a rechargeable battery, a USB connector, and control device is disclosed. The USB connector couples a detection signal and a voltage signal from the external power supply. The control device is coupled between the rechargeable battery and the USB connector and controls a charging current according to the detection signal. When the detection signal is in a first state, the control device controls the charging current as a first current. When the detection signal is in a second state, the control device controls the charging current as a second current greater than the first current.

### BACKGROUND OF THE INVENTION

1. Field of the Invention

The invention relates to a chargeable electronic device, and more particularly to a chargeable electronic device utilizing a single USB connector to charge an internal battery via an external power supply or transmit data from an external unit according to an application.

2. Description of the Related Art

Many chargeable electronic devices, such as portable electronic devices, are coupled to other systems or devices via a universal serial bus (USB) connector. The chargeable electronic devices generally comprise a rechargeable battery to provide power and a power connector to connect to a direct current (DC) voltage supply. When connecting to a DC voltage supply, a chargeable electronic device receives a DC voltage and charges an internal rechargeable battery. A USB connector and a power connector respectively occupy space of the housing of the chargeable electronic device.

FIG. 1 shows a conventional chargeable electronic device. The chargeable electronic device 10 comprises a charging current 11, a rechargeable battery 12, a power connector 13, a USB connector 14, and a processing unit 15. The power connector 13 can be coupled to a DC voltage supply (not shown in FIG. 1). When the power connector 13 connects to the DC voltage supply 13, the charging circuit 11 receives DC voltage and charges the rechargeable battery 12. The processing unit 15 is coupled to the USB connector 14. When the USB connector 14 is connected to an external system or device, the processing unit 15 processes data transmitted via the USB connector 14.

The size of a chargeable electronic device, such as a digital camera, a mobile phone, or other portable electronic device, is ideally designed to be as compact as possible for convenient carriage and use. If connector interfaces for different purposes are integrated, occupied space of the housing of the portable electronic device can be reduced with a simple and relatively more compact design.

### BRIEF SUMMARY OF THE INVENTION

Chargeable electronic devices are provided. An exemplary embodiment of a chargeable electronic device comprises a rechargeable battery, a USB connector, and a control device. The USB connector couples one voltage signal, two transmission signals, and a detection signal. The detection signal has a first state and a second state. In some embodiments, the chargeable electronic device can be coupled to a DC voltage supply system via the USB connector. When the chargeable electronic device is coupled to the DC voltage supply system, the detection signal is in the second state. The control device is coupled between the rechargeable battery and the USB connector. When the detection signal is in the first state and the voltage signal is equal to a predetermined voltage value, the control device transmits USB data through the transmission signals and charges the rechargeable battery with the voltage of the voltage signal. When the detection signal is in the second state and the voltage signal is equal to a predetermined voltage value, the control device charges the rechargeable battery with an amount of current greater than that defined by the USB specification.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional chargeable electronic device;

FIG. 2A shows a pin disposition of a standard USB connection port;

FIG. 2B shows a pins disposition of an exemplary embodiment of a USB Adapter-Converter;

FIG. 3 shows an exemplary embodiment of a chargeable electronic device; and

FIG. 4 shows an exemplary embodiment of a DC voltage supply system.

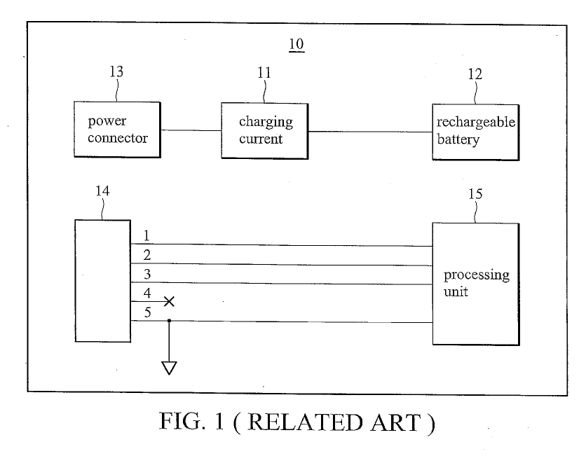

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Chargeable electronic devices are provided. An exemplary embodiment of a chargeable electronic device comprises a single universal serial bus (USB) connector. The chargeable electronic device charges and transmits data via an interface of the USB connector. This embodiment further comprises a USB Adapter-Converter and a control circuit. The USB connector can also simultaneously serve as a power connector, reducing occupied space of the chargeable electronic device.

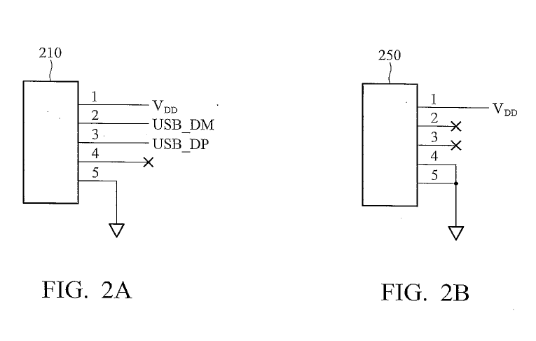

Referring to FIG. 2A, a standard USB connection port 210 has five pins. The first pin defines a voltage signal, such as a V_{DD} signal of 5V. The second and third pins define two transmission signals. The fourth and fifth pins respectively define a ground-voltage signal and a grounding signal of a connection port metal-shield. In current designs, the ground-voltage signal is not used, in other words, the fourth pin is predetermined as floating, and the fifth pin is coupled to the grounding signal to provide ground voltage. In some embodiments, the chargeable electronic device uses a voltage level of the fourth pin to serve as a detection signal for determining whether the USB connector of the chargeable electronic device is coupled to a USB transmission line or an external power adapter (such as a direct current (DC) voltage supply). In the following description, the term “ground-voltage signal” represents a grounding signal of the connection port metal-shield defined by the USB specification or ground voltage coupled to the fifth pin of a standard USB connector.

FIG. 2B shows an exemplary embodiment of a USB Adapter-Converter 250. The fourth pin of the USB Adapter-Converter 250 is coupled to ground voltage, that is the fourth pin is coupled to the fifth pin thereof. The USB Adapter-Converter 250 is used as an external power supply and converts an output terminal of the external power supply to a USB format; thus, the external power supply can be connected to the chargeable electronic device via a USB connector. Moreover, the output terminal of the external power supply can be directly charged to the structure as shown in FIG. 2B.

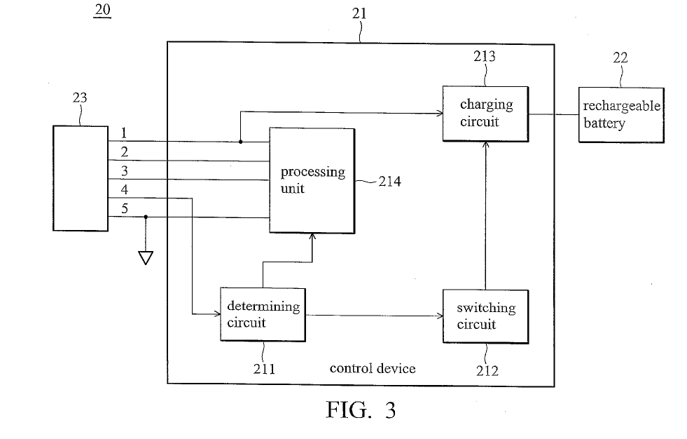

FIG. 3 shows an exemplary embodiment of a chargeable electronic device. A chargeable electronic device 20 comprises a control device 21, a rechargeable battery 22, and a USB connector 23. The control device 21 further comprises a determining circuit 211, a switching circuit 212, a charging circuit 213, and a processing unit 214.

The determining circuit 211 is coupled to the USB connector 23. When an external power supply is coupled to the USB connector 23 via a USB Adapter-Converter 250 of FIG. 2B or an external system is coupled to the USB connector 23 via a standard USB connection port 210 of FIG. 2A, the determining circuit 211 detects a state of a detection signal. In this embodiment, since the determining circuit 211 is coupled to the fourth pin of the USB connector 23, the detection signal is referred to as a signal of the fourth pin. The processing unit 214 is coupled to the first, second, and third pins of the USB connector 23. The charging circuit 213 is coupled to the USB connector 23 to receive a voltage signal (such as DC voltage V_{DD}) from the external power supply or the external system.

The determining circuit 211 can predetermine the detection signal in a first state. For example, the determining circuit 211 comprises a resistor (not shown in FIG. 3) coupling the detection signal to the voltage signal, thus, a level of the detection signal is predetermined to be at a high level. When the external system is coupled to the USB connector 23 via a standard USB connection port 210 of FIG. 2A, the high level of the detection signal is not affected and remains in the first state since the fourth pin of the standard USB connection port 210 is floating.

Moreover, when a DC voltage supply is coupled to the USB connector via a USB Adapter-Converter 250 of FIG. 2B. Since the fourth pin of the USB Adapter-Converter 250 is coupled to ground voltage, the level of the detection signal is pulled down to a low level, thus, the detection signal switches to a second state from the first state.

When the processing unit 214 receives the voltage signal, if the determining circuit 211 determines the detection signal is in the first state, it indicates that the USB connector 23 is coupled to an external system via a standard USB connection port or a USB transmission line. The processing unit 214 performs data transmission between the processing unit 214 and the external system by the second and third pins of the USB connector 23. When the processing unit 214 receives the voltage signal, if the determining circuit 211 determines the detection signal is in the second state, it indicates that the USB connector 23 is coupled to an external power supply via a USB Adapter-Converter, and the processing unit does not function.

The charging circuit 213 charges the rechargeable battery 22 with voltage provided from the voltage signal. The charging circuit 213 comprises a charging integrated circuit (IC) and a resistor network. The charging IC comprises a current programmable terminal coupled to the resistor network and alters the charging current according to the resistance of the resistor network. The resistor network comprises a first resistor operating in coordination with the charging IC to form a first mode circuit and a second resistor operating in coordination with the charging IC to form a second mode circuit.

The switching circuit 212 adjusts the resistance of the resistor network according to the determined result. When the detection signal is in the first state, the switching circuit 212 adjusts the resistor network to have a first resistance. When the detection signal is in the second state, the switching circuit 212 adjusts the resistor network to have a second resistance.

The current upper limit value, defined by the USB specification, is 0.5 A. When the USB connector 23 is coupled to a standard USB transmission line (the determining circuit 211 determines the detection signal is in the first state), the charging circuit 213 becomes the first mode circuit and charges the rechargeable battery 22 with less current (conforming the amount of current defined by USB specification). Thus, errors, generated by a system or device coupled to the standard USB transmission line due to excessive current consumption are prevented. When the USB connector 23 is coupled to a USB Adapter-Converter (the determining circuit 211 determines the detection signal is in the second state), the charging circuit 213 becomes the second mode circuit and charges the rechargeable battery 22 with greater an amount of current greater than that defined by the USB specification, thus, charge time is reduced.

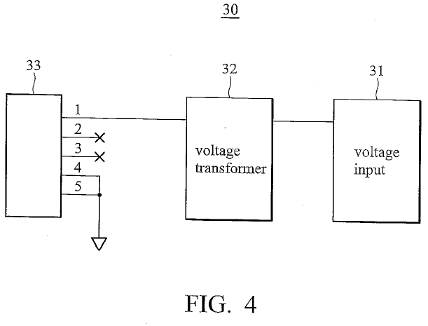

DC voltage supply systems are provided. In an exemplary embodiment of a DC voltage supply system as shown in FIG. 4, a DC voltage supply system 30 comprises a voltage input 31, a voltage transformer 32, and a USB connector 33. The DC voltage supply system 30 further comprises a light-emitting diode to indicate whether the input voltage provided by the voltage input 3 is provided normally or not. The voltage transformer 32 is coupled to the USB connector 33 through a DC voltage connector of the USB connector 33. The voltage transformer 32 transforms the input voltage to predetermined voltage defined by the USB specification. In some embodiments, the voltage input 31 can be an 110V alternating current (AC) voltage source and comprises a corresponding socket. In other some embodiments, the voltage input 31 can be a 12V DC voltage source and comprises a connector of a car cigar-lighter. In other embodiments, the voltage input 31 can be a battery or other easily obtainable voltage source.

The fifth pin of the USB connector 33 is coupled to the reference ground of the voltage input 31 or the metal-shield ground on a power source line. Note that, the fourth pin of the USB connector 33, generally predetermined to be a floating pin, is connected to the fifth pin thereof. When the DC voltage supply system 30 is coupled to the chargeable electronic device 20 of FIG. 3, the determining circuit 211 determines the detection signal is in the second state. The switching circuit 211 enables the charging circuit 213 to operate with the second mode circuit according to the determined result. The charging circuit 213 thus charges the rechargeable battery 22 with an amount of current greater than that defined by the USB specification.

According to the disclosed embodiments, a portable electronic device can be coupled to a standard USB transmission line or a DC voltage supply system via a single USB connector. When the portable electronic device is coupled to the standard USB transmission line, the portable electronic device transmits data via a USB interface and charges an internal rechargeable battery with less current. When the portable electronic device is coupled to a DC voltage supply system, the portable electronic device charges the internal rechargeable battery with greater a greater amount of current.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A chargeable electronic device charged by an external power supply comprising:
a rechargeable battery;
a universal serial bus (USB) connector coupling a detection signal and a voltage signal from the external power supply; and
a control device coupled between the rechargeable battery and the USB connector and controlling a charging current according to the detection signal;
wherein when the detection signal is in a first state, the control device controls the charging current as a first current; and
wherein when the detection signal is in a second state, the control device controls the charging current as a second current greater than the first current.

2. The chargeable electronic device as claimed in claim 1, wherein the control device comprises a determining circuit receiving the detection signal to determine a state of the detection signal.

3. The chargeable electronic device as claimed in claim 2, wherein the determining circuit receives a voltage of a predetermined pin of the external power supply to determine the state of the detection signal.

4. The chargeable electronic device as claimed in claim 3 further comprising a converter used for the external power supply and converting an output terminal of the external power supply to a USB format to connect the USB connector.

5. The chargeable electronic device as claimed in claim 4, wherein a predetermined floating pin of the USB connector couples a ground voltage to provide the detection signal and the predetermined pin is the predetermined floating pin of the USB connector.

6. The chargeable electronic device as claimed in claim 5, wherein when the determining circuit receives the ground voltage, the determining circuit determines the detection signal is in the second state.

7. The chargeable electronic device as claimed in claim 2, wherein the determining circuit determines the detection signal is in the first state when an electronic system is coupled to the USB connector via a standard USB connection port, and the predetermined floating pin of the standard USB connection port remains floating.

8. The chargeable electronic device as claimed in claim 2 further comprising a power adapter providing the external power supply to charge the chargeable electronic device, wherein the power adapter comprises a USB plug coupled to the USB connector, and a predetermined floating pin of the USB plug couples a ground voltage to provide the detection signal.

9. The chargeable electronic device as claimed in claim 2 further comprising a switching circuit selecting a first mode circuit or a second mode circuit according to the determined result of the determining circuit.

10. The chargeable electronic device as claimed in claim 9, wherein the first mode circuit has a first resistance, and the second mode circuit has a second resistance.

11. The chargeable electronic device as claimed in claim 9 further comprising a charging circuit coupled to the switching circuit and generating the corresponding charging current according to the first mode circuit or the second mode circuit.

12. A direct current (DC) voltage supply system coupled to a universal serial bus (USB) plug of an electronic system for providing a charging current greater than a current defined by the USB specification to the electronic system, the DC voltage supply system comprising:
a voltage input providing the input voltage;
a voltage transformer transforming the input voltage to a predetermined voltage defined by the USB specification; and
a USB connector coupled to the electronic device, wherein a predetermined floating pin of the USB connector couples a ground voltage.

13. The DC voltage supply system as claimed in claim 12, wherein the voltage input is an 110V alternating current (AC) voltage source.

14. The DC voltage supply system as claimed in claim 12, wherein the voltage input is a 12V DC voltage source.

15. The DC voltage supply system as claimed in claim 12, wherein the voltage input is a battery.

16. The DC voltage supply system as claimed in claim 12 further comprising a light-emitting diode indicating whether the input voltage is provided normally.
